(19) United States
(12) Patent Application Publication
(10) Pub. No.: US 2023/0289672 A1
(43) Pub. Date: Sep. 14, 2023

(54) ADAPTIVE SOCIAL ACTIVITIES FOR AUTONOMOUS VEHICLE (AV) PASSENGERS

(71) Applicant: GM Cruise Holdings LLC, San Francisco, CA (US)

(72) Inventors: Katherine Mary Stumpf, San Francisco, CA (US); Tal Sztainer Green, Berkeley, CA (US); Miles Avery Bowman, San Mateo, CA (US); Andrew David Acosta, San Francisco, CA (US)

(73) Assignee: GM Cruise Holdings LLC, San Francisco, CA (US)

(21) Appl. No.: 17/694,117

(22) Filed: Mar. 14, 2022

(51) Int. Cl. G06Q 10/06

(52) U.S. Cl. CPC G06Q 10/0631

(57) ABSTRACT

An engagement platform provides one or more engagement activities for users traveling in autonomous vehicles (AVs). An engagement activity may include a prompt (e.g., a conversation prompt or a game prompt) based on sensor data from sensors in the AV, such as interior or exterior cameras. The prompt may alternately or additionally be based on users' interests, e.g., interests determined based on users' ride history, including origin and destination locations, or interests determined based on prior engagement activities. Interior sensors may monitor users during the engagement activity, e.g., to determine whether to provide a new conversation prompt, or to determine a user's response to a game prompt.

### TECHNICAL FIELD OF THE DISCLOSURE

The present disclosure relates generally to activities for engaging vehicle passengers and, more specifically, to methods and systems for providing engaging activities for passengers during a ride service provided by an autonomous vehicle.

### BACKGROUND

In some ride service models, a single vehicle simultaneously transports multiple passengers who do not know each other in a shared ride. Certain passengers are interested in engaging with the other passengers in their vehicle, but it can be awkward to begin a conversation, or hard to tell whether another passenger may be interested in having a conversation. In addition, both solo passengers and groups of passengers, including passengers paired with strangers, may become bored during their ride.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a diagram illustrating a system including a fleet of autonomous vehicles (AVs) that can provide passenger engagement activities according to some embodiments of the present disclosure;

FIG. 2 is a block diagram illustrating a sensor suite of an AV according to some embodiments of the present disclosure;

FIG. 3 is a diagram illustrating a passenger compartment of an AV according to some embodiments of the present disclosure;

FIG. 4 is a block diagram showing the fleet management system according to some embodiments of the present disclosure;

FIG. 5 is a block diagram showing the onboard computer of the AV according to some embodiments of the present disclosure;

FIG. 6 is a flowchart of an example method for providing conversation prompts to AV users according to some embodiments of the present disclosure; and

FIG. 7 is a flowchart of an example method for providing a game to one or more AV users according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

As described herein, AVs can provide engagement activities, including conversation prompts and games, to passengers. Users can opt-in to receive conversation prompts when riding with a stranger in the AV. For example, if two users riding together in an AV have each opted in to receiving conversation prompts while riding in an AV, a passenger engagement system can determine a conversation prompt for the users based on data about the users. The passenger engagement system may utilize various real-time sensor data from the AV, including data from interior cameras, microphones, and exterior cameras, to determine a conversation prompt and, in some cases, help guide the conversation (e.g., determine whether to provide an additional conversation prompt). The passenger engagement system may alternatively or additionally use user data, such as data describing the user's current ride request and/or other requested rides (e.g., previous ride requests and/or scheduled rides requests), to select a conversation prompt. For example, to determine a potential interest in common between two users, the passenger engagement system may consider the origin location and/or destination location of each of the users (e.g., both users were picked up from movie theaters), or determine, based on interior and exterior camera data, that the users are looking at a same object outside the AV (e.g., both users are looking at a sunset). The passenger engagement system can then select a conversation prompt based on the common interest, e.g., “What is your favorite movie?” or “What is your favorite sunset that you've seen?”

As another example, users can opt-in to play a game in the AV. In some cases, multiple users who know each other (e.g., two passengers riding together) or do not know each other (e.g., two strangers on a shared ride) can play a game together. In some cases, a single users may play a game alone, using either the user's personal device (e.g., a smartphone), or using user interface components in the AV. The AV may offer various types of games, such as a scavenger hunt style game where users look for objects or answer questions related to objects outside the AV, a speed guessing game where users guess the speed of other objects traveling outside the AV, or a distance guessing game where users guess the distance to other objects outside the AV. The games may include prompts based on data obtained from AV sensors, including image data captured by exterior cameras, speed data captured by radar sensors, or distance data captured by lidar sensors. In various embodiments, the game prompts may be based on static environmental features captured by AV sensors (e.g., by data captured by one or more AVs that previously traversed an environment), or real-time environmental features captured by the AV during the game play. The games may further rely on one or more interior user interface components in the AV's passenger compartment, such as a touch screen, microphone, or cameras, to receive responses to the game prompts. In some embodiments, users in one AV may compete against users in another AV, e.g., passengers in multiple AVs traversing the same portion of a route may compete against each other.

Embodiments of the present disclosure provide a method for engaging a user in an AV, and a computer-readable medium storing instructions that, when executed by the processor, cause the processor to perform the method. The method includes determining that a user in an AV is interested in an engagement activity provided by the AV; providing, through a user interface in the AV, a prompt to the user, where at least one of the prompt and an expected response to the prompt is based on an object in an environment of the AV, the object detected by an exterior sensor mounted to an exterior of the AV; receiving, from an interior sensor in a passenger compartment of the AV, a response to the prompt; comparing the response to the expected response; and indicating, through the user interface in the AV, whether the received response matches the expected response.

Embodiments of the present disclosure also provide a system for engaging a user in an AV, the system including an exterior sensor, an interior sensor, and an engagement system. The exterior sensor is mounted to an exterior of the AV and is to obtain data describing an environment of the AV. The interior sensor is mounted in a passenger compartment of the AV and is to sense an input from a user. The engagement system is to determine that a user in an AV is interested in an engagement activity provided by the AV; provide a prompt to the user, where at least one of the prompt and an expected response to the prompt is based on an object in an environment of the AV, the object detected by the exterior sensor; receive, from the interior sensor, a response to the prompt; compare the response to the expected response; and provide an output to the user indicating whether the received response matches the expected response.

Further of the present disclosure provide for a method a method for engaging users in an AV, and a computer-readable medium storing instructions that, when executed by the processor, cause the processor to perform the method. The method includes determining that a first user in an AV is interested in having a conversation with a second user; determining that the second user in the AV is interested in having a conversation; providing, through a user interface in the AV, a first prompt to at least one of the first user and the second user, the first prompt based on an interest common to the first user and the second user; determining, based on data received from an interior sensor in a passenger compartment of the AV, to provide a second prompt; and providing, through the user interface in the AV, the second prompt to at least one of the first user and the second user.

Embodiments of the present disclosure also provide a system for engaging users in an AV, the system including an interior sensor and an engagement system. The interior sensor is in a passenger compartment of an AV and is to capture data describing an interaction between a first user and a second user. The engagement system is to determine that the first user in an AV is interested in having a conversation with the second user; determine that the second user in the AV is interested in having a conversation; provide a first prompt to at least one of the first user and the second user, the first prompt based on an interest common to the first user and the second user; determine, based on data received from the interior sensor, to provide a second prompt; and provide the second prompt to at least one of the first user and the second user.

As will be appreciated by one skilled in the art, aspects of the present disclosure, in particular aspects of passenger engagement activities, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

Example AV System for Implementing Passenger Engagement Activities

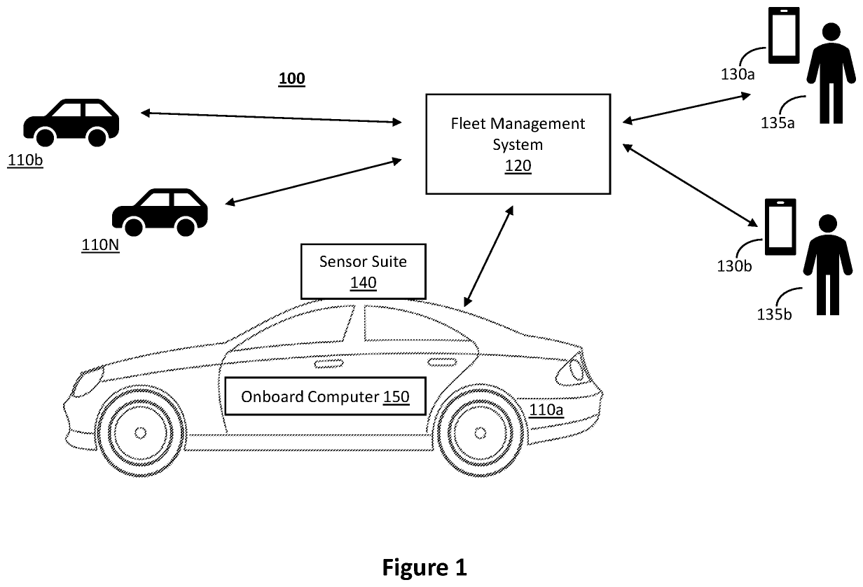

FIG. 1 is a block diagram illustrating a system 100 including a fleet of AVs that can provide passenger engagement activities, according to some embodiments of the present disclosure. The system 100 includes a fleet of AVs 110, including AV 110a, AV 110b, and AV 110N, a fleet management system 120, and user devices 130, including user devices 130a and 130b. For example, a fleet of AVs may include a number N of AVs, e.g., AV 110a through AV 110N. AV 110a includes a sensor suite 140 and an onboard computer 150. AVs 110b through 110N also include a sensor suite 140 and an onboard computer 150. A single AV in the fleet is referred to herein as AV 110, and the fleet of AVs is referred to collectively as AVs 110.

The fleet management system 120 receives service requests for the AVs from user devices, such as a user device 130. The system environment may include various user devices, e.g., user device 130a and user device 130b, associated with different users 135, e.g., user 135a and 135b. For example, a user 135a accesses an app executing on the user device 130a and requests a ride from a pickup location (e.g., the current location of the user device 130a) to a destination location. The user device 130a transmits the ride request to the fleet management system 120. The fleet management system 120 selects an AV (e.g., AV 110a) from the fleet of AVs 110 and dispatches the selected AV 110a to the pickup location to carry out the ride request. In some embodiments, the ride request further includes a number of passengers in the group. In some embodiments, the ride request indicates whether a user 135 is interested in a shared ride with another user traveling in the same direction or along a same portion of a route. The ride request, or settings previously entered by the user 135, may further indicate whether the user 135 is interested in participating in engagement activities, either alone and/or with another passenger.

The fleet management system 120 and AVs 110 implement a passenger engagement platform that provides passenger engagement activities to passengers, e.g., the users 135a and 135b. For example, both users 135a and 135b agree to receiving a shared ride, and the fleet management system 120 dispatches the AV 110a to pick up the users 135a and 135b at their respective pickup locations. Both of the users 135a and 135b have opted into a passenger engagement activity, e.g., to receive conversation prompts from the AV 110a. The passenger engagement platform provides a conversation prompt to the users 135a and 135b based on information about the users 135a and 135b, e.g., the users' pickup and/or destination locations, or interests expressed by the users. The conversation prompt may alternatively or additionally be determined based on sensor data from the AV 110a. The passenger engagement platform may monitor a conversation, e.g., to determine whether the users 135a and 135b are still talking, have stopped talking, appear bored, etc., and may determine to provide an additional conversation prompt.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

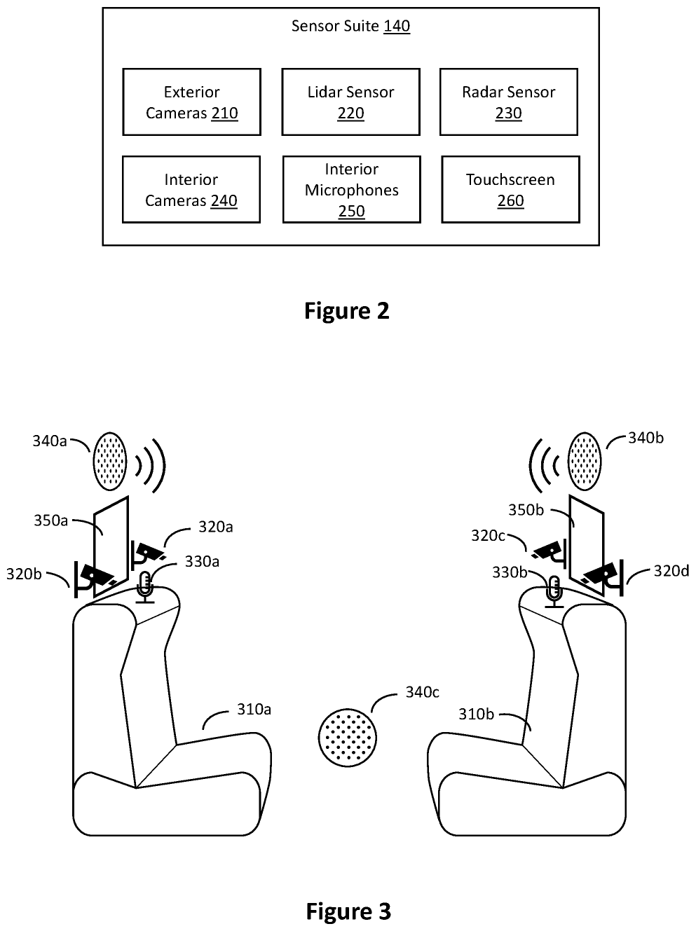

The AV 110 includes a sensor suite 140, which includes a computer vision (“CV”) system, localization sensors, and driving sensors. For example, the sensor suite 140 may include interior and exterior cameras, radar sensors, sonar sensors, lidar (light detection and ranging) sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 2.

The onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. The onboard computer 150 is preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems. Certain aspects of the onboard computer 150 are described further in relation to FIG. 5.

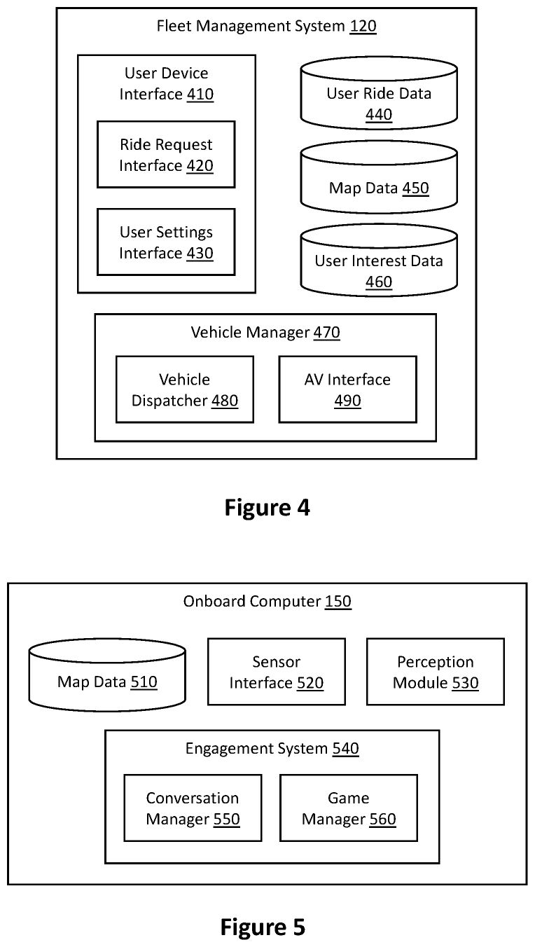

The fleet management system 120 manages the fleet of AVs 110. The fleet management system 120 may manage one or more services that provides or uses the AVs, e.g., a service for providing rides to users using the AVs. The fleet management system 120 selects one or more AVs (e.g., AV 110a) from a fleet of AVs 110 to perform a particular service or other task, and instructs the selected AV to drive to one or more particular location (e.g., a first address to pick up user 135a, and a second address to pick up user 135b). The fleet management system 120 also manages fleet maintenance tasks, such as fueling, inspecting, and servicing of the AVs. As shown in FIG. 1, the AVs 110 communicate with the fleet management system 120. The AVs 110 and fleet management system 120 may connect over a public network, such as the Internet. The fleet management system 120 is described further in relation to FIG. 4.

The user device 130 is a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs, such as a service that provides passenger rides. The service, and particularly the AVs associated with the service, is managed by the fleet management system 120, which may also provide the application to the user device 130. The application may provide a user interface to the user 135 during the rides, such as a user interface for playing a game, as described herein.

Example Sensor Suite

FIG. 2 illustrates an example AV sensor suite according to some embodiments of the present disclosure. The sensor suite 140 includes exterior cameras 210, a lidar sensor 220, a radar sensor 230, interior cameras 240, interior microphones 250, and a touchscreen 260. The sensor suite 140 may include any number of the types of sensors shown in FIG. 2, e.g., one or more exterior cameras 210, one or more lidar sensors 220, etc. The sensor suite 140 may have more types of sensors than those shown in FIG. 2, such as the sensors described with respect to FIG. 1. In other embodiments, the sensor suite 140 may not include one or more of the sensors shown in FIG. 2.

The exterior cameras 210 capture images of the environment around the AV 110. The sensor suite 140 may include multiple exterior cameras 210 to capture different views, e.g., a front-facing camera, a back-facing camera, and side-facing cameras. One or more exterior cameras 210 may be implemented using a high-resolution imager with a fixed mounting and field of view. One or more exterior cameras 210 may have adjustable field of views and/or adjustable zooms. In some embodiments, the exterior cameras 210 capture images continually during operation of the AV 110. The exterior cameras 210 may transmit the captured images to a perception module of the AV 110.

The lidar (light detecting and ranging) sensor 220 measures distances to objects in the vicinity of the AV 110 using reflected laser light. The lidar sensor 220 may be a scanning lidar that provides a point cloud of the region scanned. The lidar sensor 220 may have a fixed field of view or a dynamically configurable field of view. The lidar sensor 220 may produce a point cloud that describes, among other things, distances to various objects in the environment of the AV 110.

The radar sensor 230 can measure ranges and speeds of objects in the vicinity of the AV 110 using reflected radio waves. The radar sensor 230 may be implemented using a scanning radar with a fixed field of view or a dynamically configurable field of view. The radar sensor 230 may include one or more articulating radar sensors, long-range radar sensors, short-range radar sensors, or some combination thereof.

The interior cameras 240 capture images of a passenger compartment of the AV 110. The sensor suite 140 may include multiple interior cameras 240 to capture different views, e.g., to capture views of each seat, or portions of each seat (e.g., a portion of a seat where a user's face is typically located). The interior cameras 240 may be implemented with a fixed mounting and fixed field of view, or one or more of the interior cameras 240 may have adjustable field of views and/or adjustable zooms, e.g., to focus on user's faces. The interior cameras 240 may operate continually during operation of the AV 110, or an interior camera 240 may operate when a user is detected within the field of view of the interior camera 240. The interior cameras 240 may transmit captured images to the perception module of the AV 110.

The interior microphones 250 convert sound in the passenger compartment of the AV 110 into electrical signals. The sensor suite 140 may have multiple interior microphones 250 at various locations around the passenger compartment of the AV 110, e.g., to capture sounds from different passengers at different locations within the passenger compartment. The microphones 250 may operate continually during operation of the AV 110, or an interior microphone 250 may operate when sound is detected at the microphone and/or when a user is detected within a range of the microphone 250.

The touchscreen 260 provides output from the AV 110 and enables user to provide user input to the AV 110. A touchscreen 260 may be located above a passenger seat, in a headrest, on an armrest, etc. In some embodiments, one or more other types of user input devices may be disaggregated from a display and located in the passenger compartment, e.g., buttons or a trackpad for controlling a display mounted in the passenger compartment may be located on an armrest or in another location in the passenger compartment, and a passenger can control a display screens using the user input devices. In some embodiments, the touchscreen 260 may be implemented on a personal user device (e.g., the user device 130), and the user device 130 can transmit data received via the touchscreen (e.g., in an app provided by the fleet management system 120) to the AV 110 and/or the fleet management system 120.

Example AV Passenger Compartment

FIG. 3 is a diagram illustrating a passenger compartment of an AV 110 according to some embodiments of the present disclosure. The passenger compartment includes two rows of seats 310a and 310b that are arranged facing each other. Each row of seats 310a and 310b can seat a fixed number of passengers, e.g., two passengers or three passengers.

The passenger compartment is further equipped with interior cameras 320a, 320b, 320c, and 320d, which are examples of the interior cameras 240 described with respect to FIG. 2. In this example, each row of seats 310a and 310b has two interior cameras above it and facing the opposite row of seats. For example, if the row of seats 310a is configured to seat two passengers, the interior camera 320c is positioned to capture images of a passenger sitting on the left side of the row of seats 310a, and the interior camera 320d is positioned to capture images of a passenger sitting on the right side of the row of seats 310a. In some embodiments, a single interior camera 320 can capture a view of multiple passenger seats. The passenger compartment further includes microphones 330a and 330b for capturing audio, e.g., voices of users in the passenger compartment. The microphones 330a and 330b are examples of the interior microphones 250 described with respect to FIG. 2. In some embodiments, the microphones 330 are integrated into the interior cameras 320.

The passenger compartment further includes various output devices, such as speakers 340a, 340b, and 340c, and display screens 350a and 350b. The speakers 340a, 340b, and 340c provide audio output to the passenger compartment. The speakers 340 may be located at different points throughout the passenger compartment, and the speakers 340 may be individually or jointly controlled. The display screens 350 may be examples of the touchscreen 260 described with respect to FIG. 2. In this example, a display screen 350 is above each of the rows of seats 310a and 310b and viewable to the row of seats positioned opposite. For example, passengers seated in the row of seats 310a can view the display screen 350b. The display screens 350 may be equipped to receive user input, e.g., as a touchscreen, or through one or more buttons or other user input devices arranged proximate to each display screen 350 or elsewhere in the passenger compartment.

To determine whether a seat has a seated passenger, the onboard computer 150 may perform an image detection algorithm on images captured by each of the interior cameras 320. As another example, the passenger compartment includes weight sensors incorporated into the passenger seats that transmit weight measurements to the onboard computer 150, and the onboard computer 150 determines based on the weight measurements whether each seat has a seated passenger. In other embodiments, the onboard computer 150 uses one or more other interior sensors (e.g., lidar, radar, thermal imaging, etc.) or a combination of sensors to identify the locations of passengers seated in the AV 110. In some embodiments, the onboard computer 150 instructs interior cameras 320 directed at seats that have seated passengers to capture images, while other interior cameras 320 do not capture images.

In alternate configurations, the passenger compartment has rows of seats in different configurations (e.g., two rows facing the same direction), more rows of seats, fewer rows of seats, one or more individual seats (e.g., bucket seats), or some combination of seats (e.g., one bench seat and two bucket seats). The arrangement of the interior cameras 320, microphones 330, speakers 340, and display screens 350 may be different from the arrangement shown in FIG. 3 based on the arrangement of the seats. For example, the passenger compartment includes one or more display screens that are visible to each of the passenger seats, and video cameras that are positioned to capture a view of each passenger seat.

Example Fleet Management System

FIG. 4 is a block diagram showing the fleet management system according to some embodiments of the present disclosure. The fleet management system 120 includes a user device interface 410, various data stores 440-460, and a vehicle manager 470. The user device interface 410 includes a ride request interface 420 and user settings interface 430. The data stores include user ride data 440, map data 450, and user interest data 460. The vehicle manager 470 includes a vehicle dispatcher 480 and an AV interface 490. In alternative configurations, different and/or additional components may be included in the fleet management system 120. Further, functionality attributed to one component of the fleet management system 120 may be accomplished by a different component included in the fleet management system 120 or a different system than those illustrated.

The user device interface 410 provides interfaces to personal user devices, such as smartphones, tablets, and computers. For example, the user device interface 410 may provide one or more apps or browser-based interfaces that can be accessed by users, such as the users 135, using user devices, such as the user devices 130. The user device interface 410 includes the ride request interface 420, which enables the users to submit requests to a ride service provided or enabled by the fleet management system 120. In particular, the ride request interface 420 enables a user to submit a ride request that includes an origin (or pickup) location and a destination (or drop-off) location. The ride request may include additional information, such as a number of passengers traveling with the user, and whether or not the user is interested in shared ride with one or more other passengers not known to the user.

The user device interface 410 further includes a user settings interface 430 in which a user can select ride settings. The user settings interface 430 can provide one or more options for the user to participate in one or more engagement activities, such as receiving conversation prompts or playing a game. The user settings interface 430 may enable a user to opt-in to some, all, or none of the engagement activities offered by the ride service provider. The user settings interface 430 may further enable the user to opt-in to certain monitoring features, e.g., to opt-in to have the interior cameras 240 obtain image data for use by the engagement platform, or to have the microphones 250 obtain sound data for use by the engagement platform. The user settings interface 430 may explain how this data is used in the engagement activities (e.g., for eye or gaze tracking, to assess the flow of a conversation, to assess boredom, to hear spoken responses to game prompts, etc.) and may enable users to selectively opt-in to certain monitoring features, or to opt-out of all of the monitoring features. In some embodiments, the passenger engagement platform may provide a modified version of an engagement activity if a user has opted out of some or all of the monitoring features.

The user ride data 440 stores ride information associated with users of the ride service, e.g., the users 135. The user ride data 440 may include an origin location and a destination location for a user's current ride. The user ride data 440 may also include historical ride data for a user, including origin and destination locations, dates, and times of previous rides taken by a user. In some cases, the user ride data 440 may further include future ride data, e.g., origin and destination locations, dates, and times of planned rides that a user has scheduled with the ride service provided by the AVs 110 and fleet management system 120.

The map data 450 stores a detailed map of environments through which the AVs 110 may travel. The map data 450 includes data describing roadways, such as e.g., locations of roadways, connections between roadways, roadway names, speed limits, traffic flow regulations, toll information, etc. The map data 450 may further include data describing buildings (e.g., locations of buildings, building geometry, building types), and data describing other objects (e.g., location, geometry, object type) that may be in the environments of AV 110. The map data 450 may also include data describing other features, such as bike lanes, sidewalks, crosswalks, traffic lights, parking lots, signs, billboards, etc.

Some of the map data 450 may be gathered by the fleet of AVs 110. For example, images obtained by exterior cameras 210 of the AVs 110 may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map data 450. In some embodiments, certain feature data (e.g., seasonal data, such as Christmas decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map data 450.

The user interest data 460 stores data indicating user interests. The fleet management system 120 may include one or more learning modules (not shown in FIG. 4) to learn user interests based on user data. For example, a learning module may compare locations in the user ride data 440 with map data 450 to identify places the user has visited or plans to visit. For example, the learning module may compare an origin or destination address for a user in the user ride data 440 to an entry in the map data 450 that describes a building at that address. The map data 450 may indicate a building type, e.g., to determine that the user was picked up or dropped off at an event center, a restaurant, or a movie theater. In some embodiments, the learning module may further compare a date of the ride to event data from another data source (e.g., a third party event data source, or a third party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user interest data 460.

The learning module or another learning module may determine user interest data 460 based on other factors. For example, if the user engages in conversations with other users based on conversation prompts, the engagement platform (e.g., the engagement system 540, described below) may monitor the conversations (e.g., determine a length of time in which the user was engaged in conversation responsive to a particular prompt) to identify prompts that were engaging to the user and/or to identify prompts that were not engaging to the user. The user interest data 460 can store data based on successful and/or unsuccessful prompts that were previously provided to the user.

The user interest data 460 may store interests from other sources, e.g., interests acquired from third party data providers that obtain user data; interests expressly indicated by the user (e.g., in the user settings interface 430); other ride data (e.g., different cities or countries in which the user has used the ride service may indicate interest in these geographic areas); stored gaze detection data (e.g., particular features in environment outside AVs that the user has looked at); etc.

The vehicle manager 470 manages and communicates with the fleet of AVs 110. The vehicle manager 470 assigns the AVs 110 to various tasks and directs the movements of the AVs 110 in the fleet. The vehicle manager 470 includes a vehicle dispatcher 480 and an AV interface 490. In some embodiments, the vehicle manager 470 includes additional functionalities not specifically shown in FIG. 4. For example, the vehicle manager 470 instructs AVs 110 to drive to other locations while not servicing a user, e.g., to improve geographic distribution of the fleet, to anticipate demand at particular locations, etc. The vehicle manager 470 may also instruct AVs 110 to return to an AV facility for fueling, inspection, maintenance, or storage.

The vehicle dispatcher 480 selects AVs from the fleet to perform various tasks and instructs the AVs to perform the tasks. For example, the vehicle dispatcher 480 receives a ride request from the ride request interface 420. The vehicle dispatcher 480 selects an AV 110 to service the ride request based on the information provided in the ride request, e.g., the origin and destination locations. In some embodiments, the vehicle dispatcher 480 selects an AV 110 based on a user's interest in engagement activities. For example, if the ride request indicates that a user is interested in engagement activities, the vehicle dispatcher 480 may dispatch an AV 110 traveling along or near the route requested by the ride request that has a second passenger interested in engagement activities. Conversely, if the ride request indicates that a user is open to a shared ride but is not interested in engagement activities, the vehicle dispatcher 480 may dispatch an AV 110 traveling along or near the route requested by the ride request with a second passenger that is also not interested in engagement activities.

If multiple AVs 110 in the AV fleet are suitable for servicing the ride request, the vehicle dispatcher 480 may match users for shared rides based on an expected compatibility for engagement activities. For example, if multiple engagement activities (e.g., both conversation prompts and games, or multiple types of games) are available, the vehicle dispatcher 480 may match users with an interest in the same type of engagement activity for a ride in an AV 110. As another example, the vehicle dispatcher 480 may match users with similar user interests, e.g., as indicated by the user interest data 460. This may improve a quality of conversation or other engagement activity, as the conversation or game may focus on an interest in common to multiple users. In some embodiments, the vehicle dispatcher 480 may match users for shared rides based on previously observed compatibility or incompatibility when the users had previously shared a ride.

The vehicle dispatcher 480 or another system may maintain or access data describing each of the AVs in the fleet of AVs 110, including current location, service status (e.g., whether the AV is available or performing a service; when the AV is expected to become available; whether the AV is schedule for future service), fuel or battery level, etc. The vehicle dispatcher 480 may select AVs for service in a manner that optimizes one or more additional factors, including fleet distribution, fleet utilization, and energy consumption. The vehicle dispatcher 480 may interface with one or more predictive algorithms that project future service requests and/or vehicle use, and select vehicles for services based on the projections.

The vehicle dispatcher 480 transmits instructions dispatching the selected AVs. In particular, the vehicle dispatcher 480 instructs a selected AV to drive autonomously to a pickup location in the ride request and to pick up the user and, in some cases, to drive autonomously to a second pickup location in a second ride request to pick up a second user. The first and second user may jointly participate in an engagement activity, e.g., a cooperative game or a conversation. The vehicle dispatcher 480 may dispatch the same AV 110 to pick up additional users at their pickup locations, e.g., the AV 110 may simultaneously provide rides to three, four, or more users. The vehicle dispatcher 480 further instructs the AV to drive autonomously to the respective destination locations of the users.

The AV interface 490 interfaces with the AVs 110, and in particular, with the onboard computer 150 of the AVs 110. The AV interface 490 may receive sensor data from the AVs 110, such as camera images, captured sound, and other outputs from the sensor suite 140. The AV interface 490 may further interface with an engagement system, e.g., the engagement system 540. For example, the AV interface 490 may provide user ride data 440 and/or user interest data 460 to the engagement system 540, which may use this data to determine prompts for an engagement activity. The AV interface 490 may also provide user settings, e.g., data regarding engagement activity opt-ins and/or preferences, received through the user settings interface 430 to the engagement system 540.

Example Onboard Computer

FIG. 5 is a block diagram showing the onboard computer 150 of the AV according to some embodiments of the present disclosure. The onboard computer 150 includes map data 510, a sensor interface 520, a perception module 530, and an engagement system 540. The engagement system 540 includes a conversation manager 550 and a game manager 560. In alternative configurations, fewer, different and/or additional components may be included in the onboard computer 150. For example, components and modules for conducting route planning, controlling movements of the AV 110, and other vehicle functions are not shown in FIG. 5. Further, functionality attributed to one component of the onboard computer 150 may be accomplished by a different component included in the onboard computer 150 or a different system from those illustrated.

The map data 510 stores a detailed map that includes a current environment of the AV 110. The map data 510 may include any of the map data 450 described in relation to FIG. 4. In some embodiments, the map data 510 stores a subset of the map data 450, e.g., map data for a city or region in which the AV 110 is located.

The sensor interface 520 interfaces with the sensors in the sensor suite 140. The sensor interface 520 may request data from the sensor suite 140, e.g., by requesting that a sensor capture data in a particular direction or at a particular time. For example, in response to the perception module 530 or another module determining that a user is in a particular seat in the AV 110 (e.g., based on images from an interior camera 240, a weight sensor, or other sensors), the sensor interface 520 instructs the interior camera 240 to capture images of the user. As another example, in response to the perception module 530 or another module determining that the one or more users have entered the passenger compartment, the sensor interface 520 instructs the microphones 250 to capture sound. The sensor interface 520 is configured to receive data captured by sensors of the sensor suite 140, including data from exterior sensors mounted to the outside of the AV 110, and data from interior sensors mounted in the passenger compartment of the AV 110. The sensor interface 520 may have subcomponents for interfacing with individual sensors or groups of sensors of the sensor suite 140, such as a camera interface, a lidar interface, a radar interface, a microphone interface, etc.

The perception module 530 identifies objects and/or other features captured by the sensors of the AV 110. For example, the perception module 530 identifies objects in the environment of the AV 110 and captured by one or more exterior sensors (e.g., the sensors 210-230). The perception module 530 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc. The perception module 530 may identify travel speeds of identified objects based on data from the radar sensor 230, e.g., speeds at which other vehicles, pedestrians, or birds are traveling. As another example, the perception module 53—may identify distances to identified objects based on data (e.g., a captured point cloud) from the lidar sensor 220, e.g., a distance to a particular vehicle, building, or other feature identified by the perception module 530. The perception module 530 may also identify other features or characteristics of objects in the environment of the AV 110 based on image data or other sensor data, e.g., colors (e.g., the colors of Christmas lights), sizes (e.g., heights of people or buildings in the environment), makes and models of vehicles, pictures and/or words on billboards, etc.

The perception module 530 may further process data from captured by interior sensors (e.g., the interior cameras 240 and/or microphones 250) to determine information about and/or behaviors of passengers in the AV 110. For example, the perception module 530 may perform facial recognition based on image data from the interior cameras 240 to determine which user is seated in which position in the AV 110. As another example, the perception module 530 may process the image data to determine passengers' moods, e.g., whether passengers are engaged in conversation, or whether passengers are bored (e.g., having a blank stare, or looking at their phones). The perception module may analyze data from the microphones 250, e.g., to determine whether passengers are talking, what passengers are talking about, the mood of the conversation (e.g., cheerful, annoyed, etc.). In some embodiments, the perception module 530 may determine individualized moods, attitudes, or behaviors for the users, e.g., if one user is dominating the conversation while another user is relatively quiet or bored; if one user is cheerful while the other user is getting annoyed; etc. In some embodiments, the perception module 530 may perform voice recognition, e.g., to determine a response to a game prompt spoken by a user.

In some embodiments, the perception module 530 fuses data from one or more interior cameras 240 with data from exterior sensors (e.g., exterior cameras 210) and/or map data 510 to identify environmental features that one or more users are looking at. The perception module 530 determines, based on an image of a user, a direction in which the user is looking, e.g., a vector extending from the user and out of the AV 110 in a particular direction. The perception module 530 compares this vector to data describing features in the environment of the AV 110, including the features' relative location to the AV 110 (e.g., based on real-time data from exterior sensors and/or the AV's real-time location) to identify a feature in the environment that the user is looking at.

While a single perception module 530 is shown in FIG. 5, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The engagement system 540 provides engagement activities for one or more passengers in the AV 110. In this example, the engagement system 540 includes a conversation manager 550 that provides conversation prompts to users, and a game manager 560 that provides a game to users. In other examples, the engagement system 540 includes fewer, additional, or different engagement activities. As noted with respect to FIG. 4, the engagement system 540 may receive user settings, e.g., data regarding engagement activity opt-ins and/or preferences, from the AV interface 490. The engagement system 540 may select a particular engagement activity based on the user settings and launch the appropriate manager 550 or 560. As another example, a user may request a particular engagement activity in an in-vehicle interface, e.g., the touchscreen 260.

In this example, the engagement system 540 is implemented by the onboard computer 150. In some embodiments, the engagement system 540 is implemented in whole or in part by the fleet management system 120, e.g., by the vehicle manager 470; the engagement system 540 may interface with one or more user interface devices in the AV 110. In some embodiments, the engagement system 540 is implemented in whole or in part by a personal user device of a user, e.g., the user device 130. In some embodiments, aspects of the engagement system 540 are carried out across multiple devices, including the onboard computer 150, fleet management system 120, and/or user devices 130.

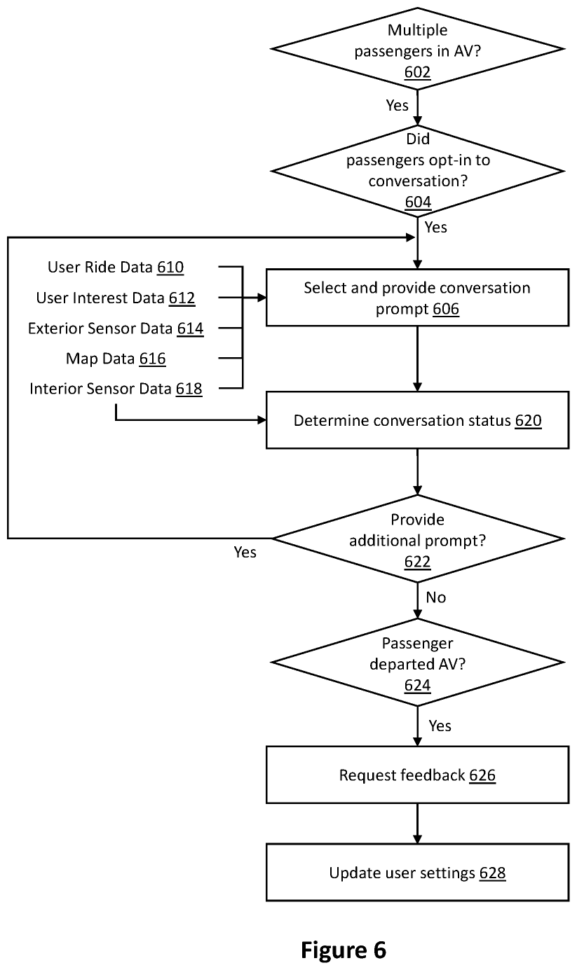

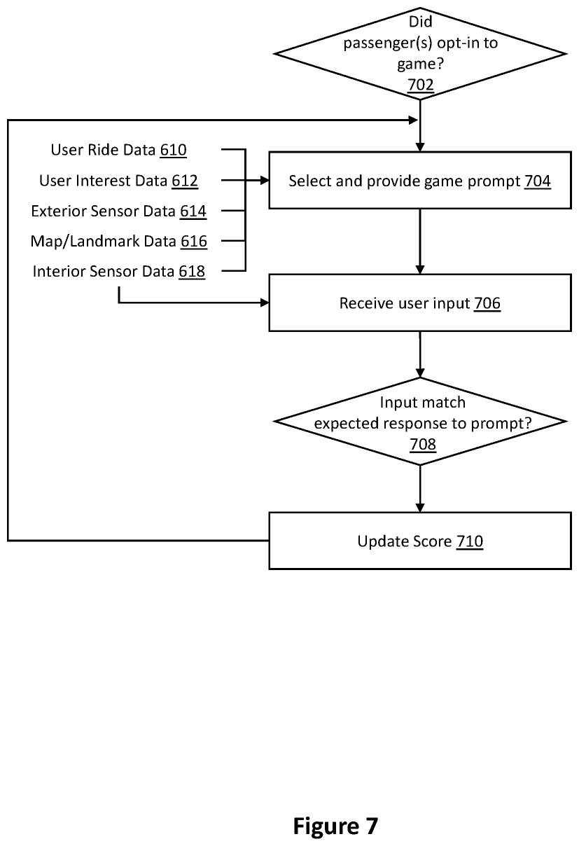

The conversation manager 550 provides conversation prompts to users who have opted in to directed conversation engagement with fellow passengers. The conversation manager 550 receives information from the fleet management system 120, e.g., user ride data 440 and/or user interest data 460, and the conversation manager 550 may use this data to determine a conversation prompt. In some embodiments, the conversation manager 550 determines a conversation prompt based on data from the sensor suite 140 and/or perception module 530, in addition to or instead of the data from the fleet management system 120. The conversation manager 550 may provide continuous or periodic monitoring of the conversation based on data from interior sensors and/or perception module 530. Based on the monitoring, the conversation manager 550 may determine to provide an additional conversation prompt, or may determine not to provide additional conversation prompts. An example process performed by the conversation manager 550 is described with respect to FIG. 6.

The game manager 560 provides game prompts to users who have opted in to play a game. A user may play a game solo or with other users in the AV 110. The game manager 560 receives information from the fleet management system 120, e.g., user settings entered in the user settings interface 430, user ride data 440, and/or user interest data 460, and the game manager 560 may use this data to select a particular type of game, or to select a game prompt. The game manager 560 may provide one or more games of various types. For example, the game manager 560 may provide a scavenger hunt game in which users look for objects or answer questions related to objects outside the AV 110. The objects a user is asked to search for, or questions a user is asked to answer, may be based on user interests, e.g., a user who is interested in cars may play a game of guessing the model year of other vehicles in the environment of the AV 110, while a user who is interested in birds may play a game of identifying species of birds in the environment of the AV 110. As another example, the game manager 560 provides a speed guessing game where users guess the speed of other objects traveling outside the AV 110. As still another example, the game manager 560 provides a distance guessing game where users guess the distance to other objects outside the AV 110. As another example, the game manager 560 provides a game where users identify other AVs 110 in the fleet of AVs traveling around the AV 110. For example, if each of the AVs in the fleet have unique names painted on the AVs' exteriors, and users can call out the names of other AVs 110 they see. To implement this game, the game manager 560 may receive real-time locations and names of other AVs 110 in the fleet from the fleet management system 120.

The game manager 560 may receive inputs, e.g., answers to the prompts, in various ways. For example, users can verbally call out answers (e.g., guesses for speeds, car model years, or bird species); the answers are detected by the microphones 250 and processed using voice recognition. Alternatively, users can type in answers on their personal user devices 130, a touchscreen 260, or other user input devices in the AV 110. As another example, if a game involves spotting objects in the environment of the AV 110, a user can make a pointing gesture to the object, and the perception module 530 can determine if the pointing direction corresponds to the object in a similar manner to the gaze determination described with respect to the perception module 530 (here, the vector from the user is based on a pointing direction of the user's hand). The game manager 560 may keep a score for the user or users based on their responses to game prompts. In some embodiments, multiple users may work together, while in other embodiments, the game manager 560 may maintain individual scores for multiple users so that the users can play against each other.

In some embodiments, users in different AVs 110 may play against each other. For example, if multiple AVs 110 are traveling on a similar route, users in each of the AVs can play a game of identifying objects along the route, and the users can play against each other for a high score. The objects may be relatively static objects that do not require AVs 110 to travel along the route simultaneously. The game managers 560 on multiple AVs 110 may communicate (e.g., via the fleet management system 120) to share scores, or a central game interface on the fleet management system 120 may keep track of and share scores from multiple AVs 110. In some embodiments, the fleet management system 120 accesses user network information to identify groups of associated users, e.g., users who live in a particular neighborhood, or users who work for the same company. The fleet management system 120 can enable users in a user network to play against each other and view each other's scores. An example process performed by the game manager 560 is described with respect to FIG. 7.

In some embodiments, the engagement system 540 (e.g., the conversation manager 550 or game manager 560) may select an engagement activity (e.g., a conversation prompt or a game) based on an expected duration of a ride. For a joint activity, such as a conversation or cooperative game, the engagement system 540 may select the activity based on an expected duration of a shared ride, e.g., how long all of the users, or how long at least two of the users, are expected to travel together before one or more users are dropped off. For example, the engagement system 540 may learn average conversation durations of particular prompts or types of prompts, and the conversation manager 550 selects a conversation prompt that is similar to the expected duration of a shared ride.

Example Method for Providing Conversation Prompts to AV Users

FIG. 6 is a flowchart of an example method for providing conversation prompts to AV users according to some embodiments of the present disclosure. An engagement platform (e.g., the conversation manager 550, or the AV interface 490) determines 602 whether there are multiple passengers in an AV 110. In some embodiments, the engagement platform may determine if there are multiple unrelated passengers, i.e., two or more users 135 that separately requested rides and are having a shared ride experience.

If there are multiple passengers in the AV 110, the engagement platform (e.g., the conversation manager 550, or the AV interface 490) determines 604 whether the passengers have opted in to having a conversation. For example, the engagement platform determines, based on settings entered by a user in a ride request or in the user settings interface 430, that two or more passengers in the AV 110 have opted in to receive conversation prompts. For example, as discussed above, the user settings interface 430 may enable users to opt-in to engagement activities or, more specifically, to conversational engagement or conversation prompts. The user settings interface 430 may further enable users to opt-in to have the AV 110 perform certain monitoring of their conversation, e.g., through sound tracking and gaze tracking.

If more than two users are in an AV 110, in some embodiments, the engagement platform may determine to provide conversation prompts if all of the users have agreed to receive conversation prompts. In other embodiments, if a subset of users have agreed to receive conversation prompts, the engagement platform may determine to direct conversation prompts to this subset of the users. The engagement platform respects privacy settings of all of the users, e.g., if two users have agreed to receive conversation prompts and to be monitored during their conversation, but another user has not opted in to be monitored, the engagement platform may not perform any monitoring of the conversation (e.g., the engagement platform does not record any audio in the AV 110), or may only perform targeted monitoring (e.g., the engagement platform performs gaze tracking of the users who have opted in, but does not perform gaze tracking of a user who has not opted in).

If passengers have opted in to participating in a conversation engagement activity, the engagement platform (e.g., the conversation manager 550) selects and provides 606 a conversation prompt for the passengers. The conversation manager 550 may receive one or more inputs, e.g., user ride data 610, user interest data 612, exterior sensor data 614, map data 616, and interior sensor data 618. The fleet management system 120 may provide certain data, e.g., the user ride data 610 (from the user ride data 440) and user interest data 612 (from the user interest data 460), to the conversation manager 550. The conversation manager 550 may receive the map data 616 from the map data 510. The conversation manager 550 may receive the exterior sensor data 614 and interior sensor data 618 from the sensor suite 140. Additionally or alternatively, the conversation manager 550 may receive information (e.g., data describing objects detected outside the AV 110, gaze direction, etc.) based on processed sensor data from the perception module 530.

The conversation manager 550 may use any of the inputs 610-618 or any combination of inputs 610-618 to select the conversation prompt. For example, the conversation manager 550 may use the inputs 610-618 to identify a common interest between users who have opted in. The common interest may include, for example, a specific location (e.g., a baseball stadium) based on user ride data 610, a type of location (e.g., movie theater, pizza shop, etc.) based on user ride data 610 and map data 616, or an interest stored in the user interest data 612 (e.g., a specific performer, based on comparing user ride data 610 to third party event information). As another example, the common interest may include an object or feature (e.g., a sunset or a billboard) that multiple users are looking at, determined based on the interior sensor data 618 (e.g., gaze direction) and exterior sensor data 614 (e.g., exterior camera data). The conversation manager 550 may output the selected conversation prompt using any output device, e.g., the touchscreen 260, or one or more speakers 340.

The conversation manager 550 may generate conversation prompts that generalize the users' interests or otherwise obfuscate user data. For example, the conversation manager 550 may avoid disclosing personal information such as home addresses or particular locations visited by users. As an example, if the conversation manager 550 receives inputs indicating that two users are both planning to attend a concert (e.g., based on planned future rides scheduled with the ride service), the conversation manager 550 may provide a prompt indicating that both users like the performer, rather than specifically saying that both users plan to attend the concert.

The conversation manager 550 may also provide prompts that go beyond identifying a common interest. For example, if the conversation manager 550 determines that both users are looking at a sunset, rather than simply noting that both users are looking at the sunset, the conversation manager 550 may provide a prompt such as “What is the best sunset you have seen?” As another example, if the conversation manager 550 determines based on ride history to restaurants that two users enjoy similar cuisines, the conversation manager 550 may prompt the users to describe their favorite foods or favorite restaurants, expecting that the users will find common ground in this conversation.

After providing the prompt, the conversation manager 550 may determine 620 a conversation status based on interior sensor data 618. For example, the conversation manager 550 may receive data from one or more interior sensors, e.g., the microphones 250 or interior cameras 240, and determine based on this data whether or not the users are engaged in conversation. During a conversation, the conversation manager 550 may determine a mood of the conversation based on verbal tones or facial expressions, e.g., whether the interaction is positive (e.g., the tone is positive and the users are engaged) or negative (e.g., the tone is angry, or one user is dominating the conversation). Alternatively or additionally, the conversation manager 550 may determine individualized moods for each user, e.g., whether each user seems happy, frustrated, annoyed, bored, etc. The conversation manager 550 may determine moods based on observations of vocal tones, facial expressions, and/or behaviors (e.g., looking at the other passenger, looking out the window, looking at a phone, etc.). If users have opted in to receiving conversational prompts, but have not opted into conversation monitoring, the conversation manager 550 may not determine the conversation status.

The conversation manager 550 determines whether to provide an additional prompt 622. If the conversation manager 550 does not monitor the conversation or determine a conversation status, the conversation manager 550 may determine to provide an additional prompt 622 after a certain period of time. If the conversation manager 550 monitors the conversation and determines a conversation status, the conversation manager 550 may determine to provide an additional prompt 622 based on the conversation status, e.g., if the conversation manager 550 determines that a conversation was positive, but the conversation has ended, or one or more users are getting bored. If the conversation manager 550 determines 622 to provide an additional prompt, the process returns to selecting and providing 606 the additional conversation prompt.

Alternatively, the conversation manager 550 may determine not to provide an additional conversation prompt, e.g., if users are still actively engaged in conversation, if the conversation went badly, if one or more of the users is actively engaged in a different activity (e.g., a user has taken a phone call), or if the shared ride is over or almost over. If no additional conversation prompt is provided, the conversation manager 550 may continue monitoring the conversation status. The engagement platform (e.g., the conversation manager 550 or fleet management system 120) may also determine 624 whether a passenger has departed the AV 110. If a passenger has departed the AV 110, the fleet management system 120 (e.g., the user device interface 410) may request 626 feedback on the engagement activity. For example, the user device interface 410 may ask a user to rate their interest in and/or relevance of the conversation prompts. As another example, the user device interface 410 may ask a user to provide feedback on the other users(s), e.g., whether or not they would want to ride with another user in the future. The fleet management system 120 updates 628 the user settings based on the feedback. For example, feedback on the prompts may be incorporated into the user interest data 460.

In some embodiments, feedback on other users and/or data based on conversation monitoring performed the conversation manager 550 and stored at the fleet management system 120 by may be used by the vehicle dispatcher 480 to make future AV dispatching decisions. For example, the fleet management system 120 may store data indicating whether two users had a positive interaction, e.g., if both users provided positive feedback in response to the request 626 for feedback, or if the conversation manager 550 determined based on interior sensor data that an interaction between the users was positive. If the ride request interface 420 receives later ride requests from the two users that can be serviced by a single shared AV 110, the vehicle dispatcher 480 may dispatch an AV 110 to pick up the users for a shared ride. Conversely, if the conversation manager 550 observed that the two users had a negative interaction, or a user indicated that he did not want to share a ride with the other user in the future, the vehicle dispatcher 480 can avoid placing this pair of users in a shared ride.

Example Method for Providing a Game to AV User or Users

FIG. 7 is a flowchart of an example method for providing a game to one or more AV users according to some embodiments of the present disclosure. An engagement platform (e.g., the game manager 560, or the AV interface 490) determines 702 whether one or more passengers riding in an AV 110 have opted in to playing a game. For example, the engagement platform determines, based on settings entered by a user in a ride request or in the user settings interface 430, that two or more passengers in the AV 110 have opted in to play a cooperative or competitive game during their ride. For example, as discussed above, the user settings interface 430 may enable users to opt-in to engagement activities or, more specifically, to playing games during rides. As another example, the engagement platform determines that a passenger has requested to play a game, either on a personal device interface (e.g., the interface of the user device 130) or an AV interface (e.g., a touchscreen 260). The user settings interface 430 and/or game request interface may further enable users to opt-in to have the AV 110 perform certain monitoring of their behaviors, e.g., using interior microphones and/or cameras to receive answers. Alternatively, users may be able to answer game prompts through other user interface devices, such as touchscreens.

If a passenger or group of passengers have opted in to participating in a game engagement activity, the engagement platform (e.g., the game manager 560) selects and provides 704 a game prompt for the passenger(s). The game manager 560 may receive one or more inputs, e.g., the user ride data 610, user interest data 612, exterior sensor data 614, map data 616, and interior sensor data 618, described with respect to FIG. 6. The game manager 560 may use any of the inputs 610-618 or combination of inputs 610-618 to select the game prompt. For example, the game manager 560 may use the inputs 610-618 to identify a user interest, or a common interest between users who have opted in, and determine a game prompt based on the interest or common interest. For example, if a user is interested in cars, the game manager 560 may select a game prompt that asks a user to identify makes, models, and/or years of cars in the environment of the AV 110. The game manager 560 may output the selected game prompt using any output device, e.g., the touchscreen 260, or one or more speakers 340.

If the game prompt involves a user finding an object outside the AV 110 (e.g., searching for another AV in the fleet, finding Christmas decorations, etc.), the game manager 560 may select prompts based on the location(s) of the user(s) in the AV 110. Different positions within the AV 110 (e.g., different seats within the passenger compartments) are associated with views of different portions of the environment of the AV 110. For example, if two users are both sitting on the right side of the AV 110, the game manager 560 may select prompts for objects or features that are on the right side of the AV 110 and visible to the users through the right-side window.

After providing the prompt, the game manager 560 receives 706 a user input responsive to the prompt. The user input may be captured by one or more of the interior sensors, e.g., the microphones 250 or interior cameras 240. For example, if the game prompt asks a user to find a 1992 Mustang in the vicinity of the AV 110, an image from an interior camera 240 may be used to determine whether the user is pointing in the direction of the 1992 Mustang observed by the AV 110. As another example, if the game prompt asks the user to identify the year of the Ford Mustang to the right of the AV 110, sound data captured by a microphone 250 may be used to determine whether a user said “1992.” Alternatively, a user may respond to a game prompt using an on-screen interface, such as a touchscreen, touchpad, or keyboard.

The game manager 560 determines 708 whether the user input matches an expected response, or correct response, to the game prompt. Based on whether the user input matches the expected response, the game manager 560 updates 710 a score of the user or users. The game manager 560 may display a running score for the game, e.g., on the touchscreen 260. As described with respect to FIG. 5, multiple AVs may play against each other, either in real-time or not, and scores of different users or AVs 110 may be shared with other users or AVs via the fleet management system 120. After updating the score, the process may proceed to selecting and providing 704 an additional game prompt. In some cases, the same game prompt may be used, e.g., if the game is to continue to spot other AVs 110 in the fleet of AVs in the environment of the AV.

After a game has ended, or after a user has departed the AV 110, the fleet management system 120 (e.g., the user device interface 410) may request feedback on the engagement activity, as described with respect to FIG. 6. For example, the user device interface 410 may ask a user to rate the game, or, if multiple users played the game together, the user device interface 410 may ask a user to provide feedback on the other users(s), e.g., whether or not they would want to ride with another user in the future. The fleet management system 120 updates user settings (e.g., the user interest data 460) based on the feedback.

As described with respect to FIG. 6, feedback on other users may be stored at the fleet management system 120 by may be used by the vehicle dispatcher 480 to make future AV dispatching decisions. In some embodiments, the game manager 560 monitors interactions between users during the games, as described with respect to FIG. 6, and data describing the interactions (e.g., whether two users had a positive interaction during the game) may be used to make future AV dispatching decisions. If the ride request interface 420 receives later ride requests from the two users that can be serviced by a single shared AV 110, the vehicle dispatcher 480 may dispatch an AV 110 to pick up the users for a shared ride if they had a positive interaction or indicated they wanted to share a ride in the future. Conversely, if the two users had a negative interaction, or a user indicated that he did not want to share a ride with the other user in the future, the vehicle dispatcher 480 can avoid placing this pair of users in a shared ride.

### Select Examples

Example 1 provides a method for engaging a user in an AV, the method including determining that a user in an AV is interested in an engagement activity provided by the AV; providing, through a user interface in the AV, a prompt to the user, where at least one of the prompt and an expected response to the prompt is based on an object in an environment of the AV, the object detected by an exterior sensor mounted to an exterior of the AV; receiving, from an interior sensor in a passenger compartment of the AV, a response to the prompt; comparing the response to the expected response; and indicating, through the user interface in the AV, whether the received response matches the expected response.

Example 2 provides the method of example 1, where the exterior sensor is a camera, and the at least one of the prompt and the expected response to the prompt is based on an object detected, using image processing, in an image captured by the camera.

Example 3 provides the method of example 1, where the exterior sensor is a radar sensor, and the at least one of the prompt and the expected response to the prompt is based on a speed of an object detected by the radar sensor. As another example, the exterior sensor is a lidar sensor, and the at least one of the prompt and the expected response to the prompt is based on a distance to an object detected by the lidar sensor.

Example 4 provides the method of example 1, where the interior sensor is a camera mounted in the passenger compartment of the AV, and the response to the prompt includes a gesture captured by the camera.

Example 5 provides the method of example 1, where the interior sensor is a microphone mounted in the passenger compartment of the AV, and the response to the prompt includes at least one word captured by the microphone.

Example 6 provides the method of example 1, where the interior sensor is a touchscreen, the touchscreen mounted in the passenger compartment or included on a mobile device, and the response to the prompt includes a user input received via the touchscreen.

Example 7 provides the method of example 1, further including identifying an interest of the user based on at least one of an origin location and a destination location of a ride requested by the user; and selecting the prompt for the user based on the identified interest.

Example 8 provides the method of example 1, further including storing a score for the user; updating the score for the user based on whether the received response matches the expected response; and displaying the updated score to the user.

Example 9 provides the method of example 8, further including providing the prompt to a second user in a second AV, the AV and the second AV traveling, at least in part, along a same route; receiving, from a second interior sensor of the second AV, a second response to the prompt; updating a second score for the second user in the second AV; and displaying the second score to the user in the AV.

Example 10 provides the method of example 1, further including determining a position within the AV of the user, the position having a view of a portion of the environment of the AV; and selecting the prompt for the user based on the position of the user.

Example 11 provides a system for engaging a user in an AV, the system including an exterior sensor mounted to an exterior of the AV, the exterior sensor to obtain data describing an environment of the AV; an interior sensor mounted in a passenger compartment of the AV, the interior sensor to sense an input from a user; and an engagement system to determine that a user in an AV is interested in an engagement activity provided by the AV; provide a prompt to the user, where at least one of the prompt and an expected response to the prompt is based on an object in an environment of the AV, the object detected by the exterior sensor; receive, from the interior sensor, a response to the prompt; compare the response to the expected response; and provide an output to the user indicating whether the received response matches the expected response.

Example 12 provides the system of example 11, where the exterior sensor is a camera, and the at least one of the prompt and the expected response to the prompt is based on an object detected, using image processing, in an image captured by the camera.

Example 13 provides the system of example 11, where the exterior sensor is a radar sensor or a lidar sensor, and the at least one of the prompt or the expected response to the prompt is based on a speed of an object detected by the radar sensor, or a distance to an object detected by the lidar sensor.

Example 14 provides the system of example 11, where the interior sensor is a camera mounted in the passenger compartment of the AV, and the response to the prompt includes a gesture captured by the camera.

Example 15 provides the system of example 11, where the interior sensor is a microphone mounted in the passenger compartment of the AV, and the response to the prompt includes at least one word captured by the microphone.

Example 16 provides the system of example 11, the engagement system further to identify an interest of the user based on at least one of an origin location and a destination location of a ride requested by the user; and select the prompt for the user based on the identified interest.

Example 17 provides the system of example 11, the engagement system further to determine a position within the AV of the user, the position having a view of a portion of the environment of the AV; and select the prompt for the user based on the position of the user.

Example 18 provides a non-transitory computer-readable medium storing instructions for engaging a user in an AV, the instructions, when executed by a processor, cause the processor to determine that a user in an AV is interested in an engagement activity provided by the AV; provide, through a user interface in the AV, a prompt to the user, where at least one of the prompt and an expected response to the prompt is based on an object in an environment of the AV, the object detected by an exterior sensor mounted to an exterior of the AV; receive, from an interior sensor in a passenger compartment of the AV, a response to the prompt; compare the response to the expected response; and indicate, through the user interface in the AV, whether the received response matches the expected response.

Example 19 provides the computer-readable medium of example 18, where the exterior sensor is a camera, and the at least one of the prompt and the expected response to the prompt is based on an object detected, using image processing, in an image captured by the camera.

Example 20 provides the computer-readable medium of example 18, where the instructions further cause the processor to identify an interest of the user based on at least one of an origin location and a destination location of a ride requested by the user; and select the prompt for the user based on the identified interest.

Example 21 provides a method for engaging users in an AV, the method including determining that a first user in an AV is interested in having a conversation with a second user; determining that the second user in the AV is interested in having a conversation; providing, through a user interface in the AV, a first prompt to at least one of the first user and the second user, the first prompt based on an interest common to the first user and the second user; determining, based on data received from an interior sensor in a passenger compartment of the AV, to provide a second prompt; and providing, through the user interface in the AV, the second prompt to at least one of the first user and the second user.

Example 22 provides the method of example 21, where determining that the first user is interested in having a conversation includes receiving, through a mobile device interface, a selection from the first user opting in to receive a conversation prompt when the first user is riding in an AV with another user.

Example 23 provides the method of example 22, where the selection is a first selection, and one of the first selection and a second selection received through the mobile device interface further opts the first user in to be monitored by the interior sensor.

Example 24 provides the method of example 21, further including identifying a first interest of the first user based on at least one of a first origin location and a first destination location of a first ride requested by the first user; and identifying a second interest of the second user based on at least one of a second origin location and a second destination location of a second ride requested by the second user; where the interest common to the first user and the second user is the first interest, and the interest common to the first user and the second user is the second interest.

Example 25 provides the method of example 21, further including determining, based on data received from an interior camera mounted in the passenger compartment of the AV, that the first user and the second user looked in a same direction; identifying, based on data received from an exterior camera mounted to an exterior of the AV, a feature in an environment of the AV in the direction that the first user and the second user looked; and determining the interest common to the first user and the second user based on the identified feature.

Example 26 provides the method of example 21, where the interior sensor is a microphone mounted in the passenger compartment of the AV, and determining to provide a second prompt includes determining, based on sound data from the microphone, that the first user and the second user are not engaged in conversation.

Example 27 provides the method of example 21, where the interior sensor is an interior camera mounted in the passenger compartment of the AV, and determining to provide a second prompt includes determining, based image data captured by the camera, that the first user and the second user are not engaged in conversation.

Example 28 provides the method of example 21, further including selecting the first prompt based on an expected shared ride duration during which both the first user and the second user are in the AV.

Example 29 provides the method of example 21, further including determining that the first user and the second user had a positive interaction; receiving a first ride request from the first user; receiving a second ride request from the second user, the first ride request and the second ride request having at least a portion of a route in common; and determine, based on the route in common and the positive interaction, to dispatch an AV to the first user and to the second user.

Example 30 provides a system for engaging users in an AV, the system including an interior sensor in a passenger compartment of an AV to capture data describing an interaction between a first user and a second user; and an engagement system to determine that the first user in an AV is interested in having a conversation with the second user; determine that the second user in the AV is interested in having a conversation; provide a first prompt to at least one of the first user and the second user, the first prompt based on an interest common to the first user and the second user; determine, based on data received from the interior sensor, to provide a second prompt; and provide the second prompt to at least one of the first user and the second user.

Example 31 provides the system of example 30, where a fleet management system is configured to receive, through a mobile device interface, a selection from the first user opting in to receive a conversation prompt when the first user is riding in an AV with another user, and the selection is used to determine that the first user in the AV is interested in having a conversation with the second user.

Example 32 provides the system of example 31, where the selection is a first selection, and one of the first selection and a second selection received through the mobile device interface further opts the first user in to be monitored by the interior sensor.

Example 33 provides the system of example 30, where the engagement system is further to identify a first interest of the first user based on at least one of a first origin location and a first destination location of a first ride requested by the first user; and identify a second interest of the second user based on at least one of a second origin location and a second destination location of a second ride requested by the second user; where the interest common to the first user and the second user is the first interest, and the interest common to the first user and the second user is the second interest.

Example 34 provides the system of example 30, the engagement system further to determine, based on data received from an interior camera mounted in the passenger compartment of the AV, that the first user and the second user looked in a same direction; identify, based on data received from an exterior camera mounted to an exterior of the AV, a feature in an environment of the AV in the direction that the first user and the second user looked; and determine the interest common to the first user and the second user based on the identified feature.

Example 35 provides the system of example 30, where the interior sensor is a microphone mounted in the passenger compartment of the AV, and determining to provide a second prompt includes determining, based on sound data from the microphone, that the first user and the second user are not engaged in conversation.

Example 36 provides the system of example 30, where the interior sensor is an interior camera mounted in the passenger compartment of the AV, and determining to provide a second prompt includes determining, based image data captured by the camera, that the first user and the second user are not engaged in conversation.

Example 37 provides the system of example 30, where the engagement system is to select the first prompt based on an expected shared ride duration during which both the first user and the second user are in the AV.

Example 38. A non-transitory computer-readable medium storing instructions for engaging users in an AV, the instructions, when executed by a processor, cause the processor to determine that a first user in an AV is interested in having a conversation with a second user; determine that the second user in the AV is interested in having a conversation; provide, through a user interface in the AV, a first prompt to at least one of the first user and the second user, the first prompt based on an interest common to the first user and the second user; determine, based on data received from an interior sensor in a passenger compartment of the AV, to provide a second prompt; and provide, through the user interface in the AV, the second prompt to at least one of the first user and the second user.

Example 39 provides the computer-readable medium of example 38, where the instructions further cause the processor to identify a first interest of the first user based on at least one of a first origin location and a first destination location of a first ride requested by the first user; and identify a second interest of the second user based on at least one of a second origin location and a second destination location of a second ride requested by the second user; where the interest common to the first user and the second user is the first interest, and the interest common to the first user and the second user is the second interest.

Example 40 provides the computer-readable medium of example 38, where the instructions further cause the processor to determine, based on data received from an interior camera mounted in the passenger compartment of the AV, that the first user and the second user looked in a same direction; identify, based on data received from an exterior camera mounted to an exterior of the AV, a feature in an environment of the AV in the direction that the first user and the second user looked; and determine the interest common to the first user and the second user based on the identified feature.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method for engaging users in an autonomous vehicle (AV), the method comprising:
determining that a first user in an AV is interested in having a conversation with a second user;
determining that the second user in the AV is interested in having a conversation;
providing, through a user interface in the AV, a first prompt to at least one of the first user and the second user, the first prompt based on an interest common to the first user and the second user;
determining, based on data received from an interior sensor in a passenger compartment of the AV, to provide a second prompt; and
providing, through the user interface in the AV, the second prompt to at least one of the first user and the second user.

2. The method of claim 1, wherein determining that the first user is interested in having a conversation comprises receiving, through a mobile device interface, a selection from the first user opting in to receive a conversation prompt when the first user is riding in an AV with another user.

3. The method of claim 2, wherein the selection is a first selection, and one of the first selection and a second selection received through the mobile device interface further opts the first user in to be monitored by the interior sensor.

4. The method of claim 1, further comprising:
identifying a first interest of the first user based on at least one of a first origin location and a first destination location of a first ride requested by the first user; and
identifying a second interest of the second user based on at least one of a second origin location and a second destination location of a second ride requested by the second user;
wherein the interest common to the first user and the second user is the first interest, and the interest common to the first user and the second user is the second interest.

5. The method of claim 1, further comprising:
determining, based on data received from an interior camera mounted in the passenger compartment of the AV, that the first user and the second user looked in a same direction;
identifying, based on data received from an exterior camera mounted to an exterior of the AV, a feature in an environment of the AV in the direction that the first user and the second user looked; and
determining the interest common to the first user and the second user based on the identified feature.

6. The method of claim 1, wherein the interior sensor is a microphone mounted in the passenger compartment of the AV, and determining to provide a second prompt includes determining, based on sound data from the microphone, that the first user and the second user are not engaged in conversation.

7. The method of claim 1, wherein the interior sensor is an interior camera mounted in the passenger compartment of the AV, and determining to provide a second prompt includes determining, based image data captured by the camera, that the first user and the second user are not engaged in conversation.

8. The method of claim 1, further comprising selecting the first prompt based on an expected shared ride duration during which both the first user and the second user are in the AV.

9. The method of claim 1, further comprising:
determining that the first user and the second user had a positive interaction;
receiving a first ride request from the first user;
receiving a second ride request from the second user, the first ride request and the second ride request having at least a portion of a route in common; and
determine, based on the route in common and the positive interaction, to dispatch an AV to the first user and to the second user.

10. A system for engaging users in an autonomous vehicle (AV), the system comprising:
an interior sensor in a passenger compartment of an AV to capture data describing an interaction between a first user and a second user; and
an engagement system to:
determine that the first user in an AV is interested in having a conversation with the second user;
determine that the second user in the AV is interested in having a conversation;
provide a first prompt to at least one of the first user and the second user, the first prompt based on an interest common to the first user and the second user;
determine, based on data received from the interior sensor, to provide a second prompt; and
provide the second prompt to at least one of the first user and the second user.

11. The system of claim 10, wherein a fleet management system is configured to receive, through a mobile device interface, a selection from the first user opting in to receive a conversation prompt when the first user is riding in an AV with another user, and the selection is used to determine that the first user in the AV is interested in having a conversation with the second user.

12. The system of claim 11, wherein the selection is a first selection, and one of the first selection and a second selection received through the mobile device interface further opts the first user in to be monitored by the interior sensor.

13. The system of claim 10, wherein the engagement system is further to:
identify a first interest of the first user based on at least one of a first origin location and a first destination location of a first ride requested by the first user; and
identify a second interest of the second user based on at least one of a second origin location and a second destination location of a second ride requested by the second user;
wherein the interest common to the first user and the second user is the first interest, and the interest common to the first user and the second user is the second interest.

14. The system of claim 10, the engagement system further to:
determine, based on data received from an interior camera mounted in the passenger compartment of the AV, that the first user and the second user looked in a same direction;
identify, based on data received from an exterior camera mounted to an exterior of the AV, a feature in an environment of the AV in the direction that the first user and the second user looked; and
determine the interest common to the first user and the second user based on the identified feature.

15. The system of claim 10, wherein the interior sensor is a microphone mounted in the passenger compartment of the AV, and determining to provide a second prompt includes determining, based on sound data from the microphone, that the first user and the second user are not engaged in conversation.

16. The system of claim 10, wherein the interior sensor is an interior camera mounted in the passenger compartment of the AV, and determining to provide a second prompt includes determining, based image data captured by the camera, that the first user and the second user are not engaged in conversation.

17. The system of claim 10, wherein the engagement system is to select the first prompt based on an expected shared ride duration during which both the first user and the second user are in the AV.

18. A non-transitory computer-readable medium storing instructions for engaging users in an autonomous vehicle (AV), the instructions, when executed by a processor, cause the processor to:
determine that a first user in an AV is interested in having a conversation with a second user;
determine that the second user in the AV is interested in having a conversation;
provide, through a user interface in the AV, a first prompt to at least one of the first user and the second user, the first prompt based on an interest common to the first user and the second user;
determine, based on data received from an interior sensor in a passenger compartment of the AV, to provide a second prompt; and
provide, through the user interface in the AV, the second prompt to at least one of the first user and the second user.

19. The computer-readable medium of claim 18, wherein the instructions further cause the processor to:
identify a first interest of the first user based on at least one of a first origin location and a first destination location of a first ride requested by the first user; and
identify a second interest of the second user based on at least one of a second origin location and a second destination location of a second ride requested by the second user;
wherein the interest common to the first user and the second user is the first interest, and the interest common to the first user and the second user is the second interest.

20. The computer-readable medium of claim 18, wherein the instructions further cause the processor to:
determine, based on data received from an interior camera mounted in the passenger compartment of the AV, that the first user and the second user looked in a same direction;
identify, based on data received from an exterior camera mounted to an exterior of the AV, a feature in an environment of the AV in the direction that the first user and the second user looked; and
determine the interest common to the first user and the second user based on the identified feature.
